(19) United States
(12) Patent Application Publication
(10) Pub. No.: US 2024/0234736 A9
(43) Pub. Date: Jul. 11, 2024

(54) ELECTRODE MIXTURE AND RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Hidenori YOKOO, Kosai-shi (JP); Ryotaro SAKAI, Toyohashi-shi, (JP); Nobuaki KOIWA, Gamagori-shi (JP); Kentaro SUZUKI, Kariya-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/382,433

(22) Filed: Oct. 20, 2023

(30) Foreign Application Priority Data
Oct. 25, 2022 (JP) 2022-170642

(51) Int. Cl. H01M 4/62; C01B 32/159; C01B 32/168

(52) U.S. Cl. CPC H01M 4/625; C01B 32/159; C01B 32/168; H01M 4/626; C01B 2202/02; C01B 2202/06; C01B 2202/22; C01P 2006/40

(57) ABSTRACT

An electrode mixture including an electrode active material, a conductive fibrous carbon material, and inorganic nanoparticles applied to a surface of the electrode active material. The conductive fibrous carbon material contains magnetic metal. A ratio of coverage of the inorganic nanoparticles covering the surface of the electrode active material to content of the magnetic metal contained in the conductive fibrous carbon material is 38.5 or less.

### BACKGROUND

### 1. Field

The present disclosure relates to an electrode mixture and a rechargeable battery.

### 2. Description of Related Art

An electrode mixture used to form an electrode active material layer contains conductive fibrous carbon material such as a carbon nanotubes. The conductive fibrous carbon material is dispersed in the electrode mixture. The conductive fibrous carbon material, which is a conductive material, forms a conductive path in the electrode active material. Japanese Laid-Open Patent Publication No. 2021-150214 discloses an example of carbon nanotubes containing magnetic metal such as iron, cobalt, or nickel. Such a structure improves the battery performance.

### SUMMARY

It is desirable that the performance of a battery be further improved for applications such as battery electric vehicles that are required to have high battery performance In addition, it is desirable that the electrode mixture and the materials of the electrode mixture have, for example, higher flowability so that they become easier to handle and allow for improved productivity. Thus, there is still room for improvement.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is an electrode mixture including an electrode active material, a conductive fibrous carbon material, and inorganic nanoparticles applied to a surface of the electrode active material. The conductive fibrous carbon material contains magnetic metal. A ratio of coverage of the inorganic nanoparticles covering the surface of the electrode active material to content of the magnetic metal contained in the conductive fibrous carbon material is 38.5 or less.

In the electrode mixture, the coverage of the inorganic nanoparticles may be 5% or greater and 15% or less.

In the electrode mixture, the content of the magnetic metal may be 0.1 wt % or greater and 5 wt % or less.

In the electrode mixture, the conductive fibrous carbon material is multi-walled carbon nanotubes, and content of the conductive fibrous carbon material contained in the electrode mixture is 0.4 wt % or greater.

In the electrode mixture, the conductive fibrous carbon material is single-walled carbon nanotubes, and content of the conductive fibrous carbon material contained in the electrode mixture is 0.04 wt % or greater.

A further aspect of the present disclosure is a rechargeable battery including the electrode mixture described above.

Other features and aspects will be apparent from the following detailed description, the drawings, and the claims.

### BRIEF DESCRIPTION OF THE DRAWINGS

FIG. 1 is a perspective view of a rechargeable battery.

FIG. 2 is an exploded view of an electrode body.

FIG. 3 is a front view of the rechargeable battery.

FIG. 4 is a diagram illustrating an electrode mixture including electrode active material and carbon nanotubes.

FIG. 5 is a diagram illustrating the electrode mixture including inorganic nanoparticles, which are applied to a surface of the electrode active material, coexisting with metal-containing carbon nanotubes, which contain magnetic metal.

FIG. 6 is a diagram schematically illustrating a metal-containing carbon nanotube.

FIG. 7 is a diagram schematically illustrating the surface of the electrode active material where inorganic nanoparticles coexist with purified carbon nanotubes, which do not contain magnetic metal.

FIG. 8 is a diagram illustrating the electrode mixture including inorganic nanoparticles, which are applied to the surface of the electrode active material, coexisting with purified carbon nanotubes.

FIG. 9 is a diagram schematically illustrating the surface of the electrode active material where inorganic nanoparticles coexist with metal-containing carbon nanotubes.

FIG. 10 is a graph illustrating DC resistance measured, under the condition that inorganic nanoparticles were not present, when using purified carbon nanotubes and when using metal-containing carbon nanotubes.

FIG. 11 is a graph illustrating the DC resistance measured, under the condition that inorganic nanoparticles were present, when using purified carbon nanotubes and when using metal-containing carbon nanotubes.

FIG. 12 is a graph illustrating a total resistance measured for cases in which inorganic nanoparticles were present and inorganic nanoparticles were not present when the carbon nanotubes contained magnetic metal and when the carbon nanotubes did not contain magnetic metal.

FIG. 13 is a graph illustrating penetration resistance for cases in which inorganic nanoparticles were present and inorganic nanoparticles were not present when the carbon nanotubes contained magnetic metal and when the carbon nanotubes did not contain magnetic metal.

FIG. 14 is a graph illustrating the DC resistance for cases in which inorganic nanoparticles were present and inorganic nanoparticles were not present when the carbon nanotubes contained magnetic metal and when the carbon nanotubes did not contain magnetic metal.

FIG. 15 is a graph illustrating reaction resistance for cases in which inorganic nanoparticles were present and inorganic nanoparticles were not present when the carbon nanotubes contained magnetic metal and when the carbon nanotubes did not contain magnetic metal.

FIG. 16 is a table illustrating the penetration resistance with respect to the coverage of the inorganic nanoparticles covering the electrode active material surface and the content of magnetic metal contained in the carbon nanotubes.

FIG. 17 is a graph illustrating the penetration resistance with respect to the coverage of the inorganic nanoparticles covering the electrode active material surface and the content of magnetic metal contained in the carbon nanotubes.

FIG. 18 is a table illustrating values obtained from ratios of the inorganic nanoparticles covering the electrode active material surface to the content of magnetic metal contained in the carbon nanotubes.

FIG. 19 is a graph illustrating values obtained from ratios of the coverage of the inorganic nanoparticles covering the electrode active material surface to the content of magnetic metal contained in the carbon nanotubes.

FIG. 20 is a table illustrating the relationship of the content of multi-walled carbon nanotubes contained in the electrode mixture with respect to the penetration resistance.

FIG. 21 is a graph illustrating the relationship of the content of multi-walled carbon nanotubes contained in the electrode mixture with respect to the penetration resistance.

FIG. 22 is a table illustrating the relationship of the content of single-walled carbon nanotubes contained in the electrode mixture with respect to the penetration resistance.

FIG. 23 is a graph illustrating the relationship of the content of single-walled carbon nanotubes contained in the electrode mixture with respect to the penetration resistance.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art

One embodiment of a rechargeable battery and an electrode will now be described with reference to the drawings.

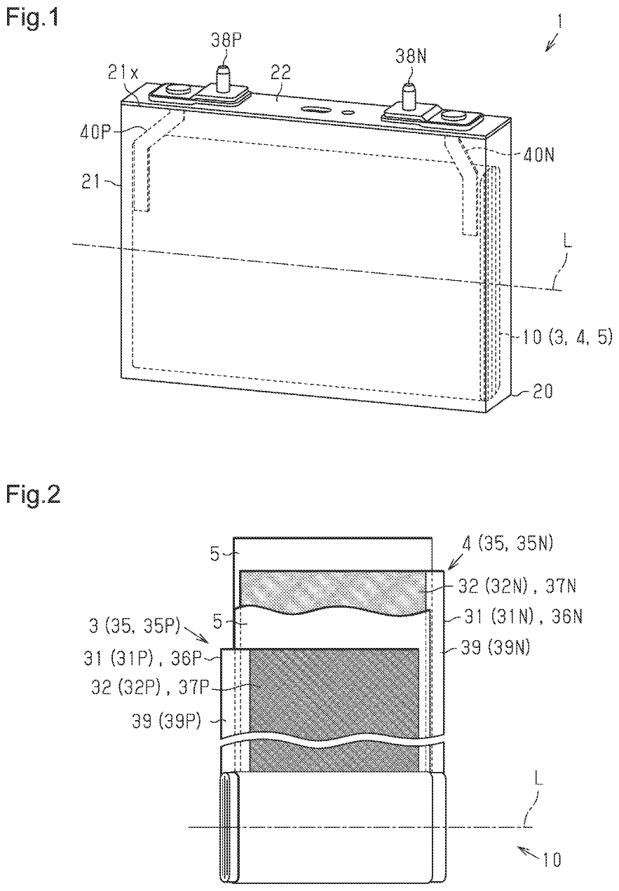

As shown in FIG. 1, a rechargeable battery 1 includes an electrode body 10 and a case 20 accommodating the electrode body 10. The electrode body 10 integrates a positive electrode 3, a negative electrode 4, and separators 5. The rechargeable battery 1 of the present embodiment is a lithium-ion rechargeable battery that immerses the electrode body 10 in a non-aqueous electrolyte solution (not shown) inside the case 20.

In the rechargeable battery 1 of the present embodiment, the positive electrode 3, the negative electrode 4, and the separators 5 are stacked sheets. The stack of the positive electrode 3, the negative electrode 4, and the separators 5 is rolled in a state in which the separators 5 are held between the positive electrode 3 and the negative electrode 4 to form the electrode body 10 so that the positive electrode 3, the negative electrode 4, and the separator 5 are arranged in an alternating manner in the radial direction of the rolled stack.

The case 20 of the present embodiment includes a case body 21, which has the form of a flattened box, and a lid 22, which closes an open end 21x of the case body 21. The electrode body 10 of the present embodiment has a flattened form and is shaped in conformance with the box-shaped case 20.

As shown in FIG. 2, in the rechargeable battery 1 of the present embodiment, the positive electrode 3 and the negative electrode 4 are each formed by an electrode sheet 35 that includes a collector 31 and electrode active material 32 applied to the collector 31.

More specifically, the electrode sheet 35P of the positive electrode 3 is formed by applying a mixture paste 37P, which contains lithium transition metal oxide that serves as the positive electrode active material, to a substrate 36P, which is formed from aluminum or the like and serves as the positive electrode collector 31P. The electrode sheet 35N of the negative electrode 4 is formed by applying a mixture paste 37N, which contains carbon material that serves as the negative electrode active material, is applied to a substrate 36N, which is formed from copper or the like and serves as the negative electrode collector 31N. The mixture pastes 37P and 37N each include a binder. In the rechargeable battery 1 of the present embodiment, the mixture pastes 37P and 37N are dried to form a positive electrode active material layer 32P and a negative electrode active material layer 32N on the corresponding positive and negative electrode sheets 35P and 35N.

Further, in the rechargeable battery 1 of the present embodiment, the positive and negative electrode sheets 35P and 35N are shaped as strips. In the electrode body 10 of the present embodiment, the stack of the positive and negative electrode sheets 35P and 35N, and the separators 5 held in between, is rolled about a rolling axis L extending in the widthwise direction of the strips (lateral direction in FIG. 2).

In FIG. 2, the separators 5 and the electrode sheets 35 are rolled with the electrode sheet 35P, which forms the positive electrode 3, arranged at the inner side. The drawing shows one example of the structure of the electrode body 10. Thus, the separators 5 and the electrode sheets 35 may be rolled with the electrode sheet 35N, which forms the negative electrode 4, arranged at the inner side. This determines whether the electrode sheet 35 arranged at the outermost part of the electrode body 10 is the electrode sheet 35P forming the positive electrode 3 or the electrode sheet 35N forming the negative electrode 4.

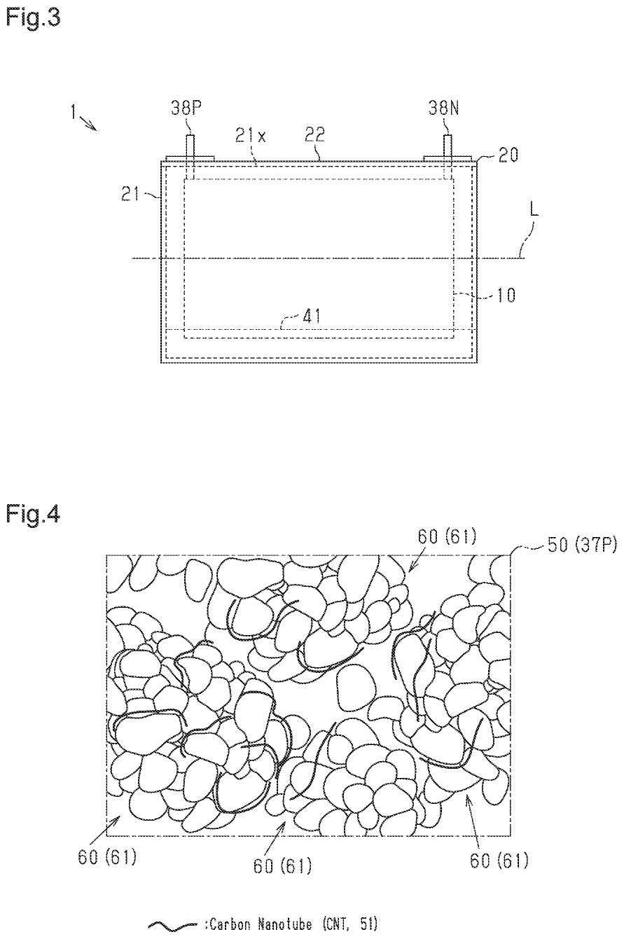

As shown in FIGS. 1 to 3, the lid 22 of the case 20 includes a positive electrode terminal 38P and a negative electrode terminal 38N that project outward from the case 20. Further, the collector 31 of each electrode sheet 35 includes an uncoated portion 39 where the electrode active material layer 32 is not applied. In the rechargeable battery 1 of the present embodiment, the uncoated portion 39 electrically connects the electrode sheet 35P, which forms the positive electrode 3, to the positive electrode terminal 38P or electrically connects the electrode sheet 35N, which forms the negative electrode 4, to the negative electrode terminal 38N.

The electrode body 10 of the present embodiment is accommodated in the case 20 so that the rolling axis L of the electrode body 10 extends in the longitudinal direction of the rectangular lid 22 (lateral direction in FIG. 1). In this state, the uncoated portion 39P of the electrode sheet 35P, which forms the positive electrode 3, is connected to the positive electrode terminal 38P by a connecting member 40P. In the same manner, the uncoated portion 39N of the electrode sheet 35N, which forms the negative electrode 4, is connected to the negative electrode terminal 38N by a connecting member 40N.

The case 20 is filled with an electrolyte solution 41. The rechargeable battery 1 of the present embodiment uses a fluoride electrolyte solution 41 in which lithium salt serving as a support salt is dissolved in an organic solvent. The electrode body 10 of the rechargeable battery 1 is immersed in the electrolyte solution 41 inside the case 20 of which the open end 21x is closed by the lid 22.

Electrode Mixture

The electrode mixture used to form the rechargeable battery 1 of the present embodiment will now be described.

Referring to FIG. 4, in the rechargeable battery 1 of the present embodiment, an electrode mixture 50 used to form the electrode body 10, more specifically, the positive electrode active material layer 32P of the positive electrode 3, contains carbon nanotubes CNT, which serve as conductive fibrous carbon material 51. More specifically, the electrode mixture 50 is applied as the mixture paste 37P to the positive electrode collector 31P (refer to FIG. 2). In the electrode mixture 50 of the present embodiment, the carbon nanotubes CNT are dispersed in the electrode mixture 50. In the electrode mixture 50, the carbon nanotubes CNT form conductive paths in regions of an electrode active material 60 proximate to the carbon nanotubes CNT. The electrode active material 60 is a positive electrode active material 61 of the positive electrode 3.

In the electrode mixture 50 of the present embodiment, the positive electrode active material 61 includes aggregates of the lithium transition metal oxide referred to as primary particle, agglomerates that are masses of the primary particles and referred to as secondary particles. The carbon nanotubes CNT are dispersed in the electrode mixture 50 in a state adhered to the surfaces of the secondary particles.

Preferably, the carbon nanotubes CNT have an average length of, for example, 100 nm or greater and 10000 nm or less. When the carbon nanotubes CNT are too short, sufficient conductivity may not be obtained. When the carbon nanotubes CNT are too long, the dispersibility will decrease and lower the conductivity of the carbon nanotubes CNT. The carbon nanotubes CNT have an average diameter of, for example, 1 nm or greater and 100 nm or less.

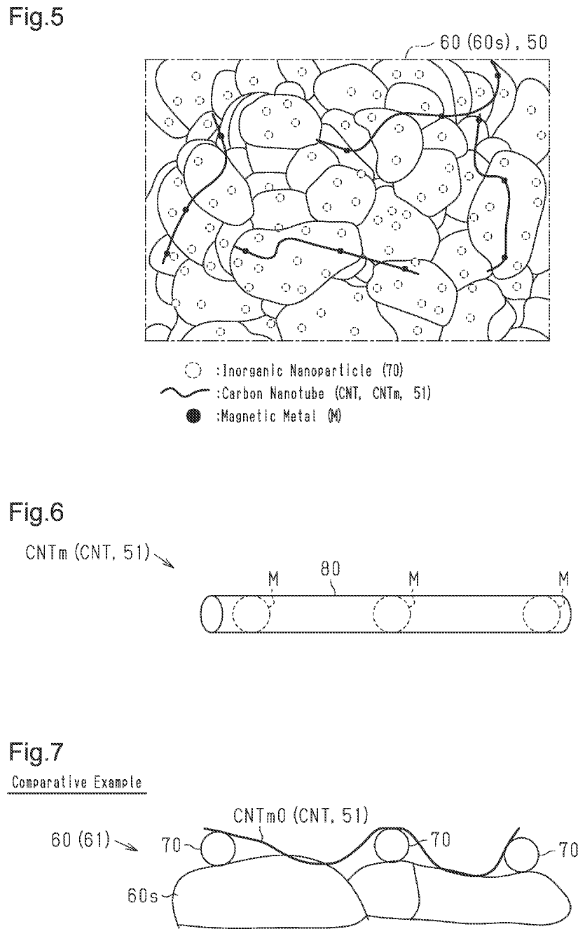

As shown in FIG. 5, the electrode mixture 50 of the present embodiment includes inorganic nanoparticles 70 adhered to a surface 60s of the electrode active material 60. In FIG. 5, the regions encompassed by the broken lines indicate the inorganic nanoparticles 70 adhered to the surface 60s of the electrode active material 60.

The particles of the electrode active material 60 may be reduced in diameter to increase the specific surface area of the electrode active material 60 and improve the battery performance. This will, however, decrease the powder flowability. Thus, when manufacturing the electrode mixture 50, the flow of raw material, or the electrode active material 60, which is in the form of powder, will be impeded. This will result in difficulties when handling the electrode active material 60.

In this regard, in the rechargeable battery 1 of the present embodiment, the electrode active material 60 is used as the raw material of the electrode mixture 50 in a state in which the inorganic nanoparticles 70 are adhered to the surface 60s. More specifically, the inorganic nanoparticles 70 are applied to the surface 60s of the electrode active material 60 to improve the powder flowability of the electrode active material 60. For example, aluminum, lithium tungstate, or the like may be used as the inorganic nanoparticles 70, which produces a powder lubricating effect. The inorganic nanoparticles 70 have a particle diameter of, for example, 1 nm or greater and 500 nm or less. Thus, the rechargeable battery 1 of the present embodiment increases the flowability of the electrode active material 60 when the electrode mixture 50 is manufactured. This facilitates handling of the electrode active material 60 and improves productivity.

Metal-Containing Carbon Nanotubes

In further detail, as shown in FIG. 6, in the rechargeable battery 1 of the present embodiment, the conductive fibrous carbon material 51, which is mixed in the electrode mixture 50, has metal-containing carbon nanotubes CNTm that are tubular structures 80 containing magnetic metal M therein. The magnetic metal M in the tubular structures 80 are attracted to the metal oxides composing the electrode active material 60. Thus, the metal-containing carbon nanotubes CNTm are readily adhered to the surface 60s of the electrode active material 60. The magnetic metal M in the metal-containing carbon nanotubes CNTm that produce such an attracting effect may be, for example, nickel (Ni), cobalt (Co), iron (Fe), or the like. In many cases, lithium transition metal oxide composes 50% or more of the positive electrode active material 61 to produce a force attracting the magnetic metal M in the metal-containing carbon nanotubes CNTm. The rechargeable battery 1 of the present embodiment uses the effect that attracts the metal-containing carbon nanotubes CNTm to the surface 60s of the electrode active material 60 so that high battery performance can be obtained with the coexisting inorganic nanoparticles 70.

Decrease in Battery Output When Inorganic Nanoparticles Cover Electrode Active Material Surface

As described above, the inorganic nanoparticles 70 on the surface 60s of the electrode active material 60 improves the powder flowability of the electrode active material 60. The inorganic nanoparticles 70, however, cover the surface 60s of the electrode active material 60 and hinders battery reactions. The decrease in battery output caused by the inorganic nanoparticles 70, which cover the surface 60s of the electrode active material 60, tends to become pronounced when the conductive fibrous carbon material 51 is purified carbon nanotubes CNTm0 that do not contain magnetic metal M.

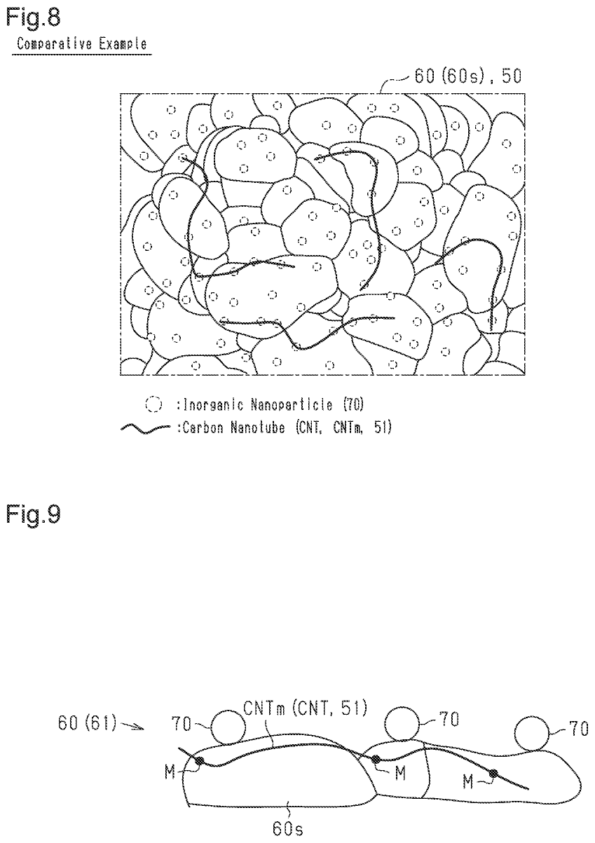

More specifically, as shown in FIGS. 7 and 8, when the inorganic nanoparticles 70 coexist with the purified carbon nanotubes CNTm0, the purified carbon nanotubes CNTm0 will easily adhere to the inorganic nanoparticles 70, which are applied to the surface 60s of the electrode active material 60. The inorganic nanoparticles 70 will interfere with the purified carbon nanotubes CNTm0 that are to contact the surface 60s of the electrode active material 60. It is understood that this will hinder battery reactions.

Operation

As shown in FIGS. 5 and 9, when the metal-containing carbon nanotubes CNTm are used, the magnetic metal M contained therein will be attracted to the electrode active material 60. Thus, the metal-containing carbon nanotubes CNTm will easily adhere to the surface 60s of the electrode active material 60. The rechargeable battery 1 of the present embodiment uses the carbon nanotubes CNT as conductive material. This increases the battery output, while improving the powder flowability with the inorganic nanoparticles 70 applied to the surface 60s of the electrode active material 60.

Optimal Design

In the electrode mixture 50 of the present embodiment, the coverage of the inorganic nanoparticles 70 covering the surface 60s of the electrode active material 60 is preferably, for example, 5% or greater and 15% or less. The coverage of the inorganic nanoparticles 70 may be obtained from, for example, a linear approximate equation of the content (wt %) of the inorganic nanoparticles 70 contained in the electrode mixture 50 and the average diameter (nm) of the inorganic nanoparticles 70. The preferable powder flowability is obtained when the coverage of the inorganic nanoparticles 70 is 5% or greater. When the coverage of the inorganic nanoparticles 70 is 15% or less, the inorganic nanoparticles 70 covering the surface 60s of the electrode active material 60 will limit decreases in the battery output.

Preferably, the content of the magnetic metal M contained in the metal-containing carbon nanotubes CNTm is, for example, 0.1 wt % or greater and 5 wt % or less. The content of the magnetic metal M may be measured through, for example, inductively coupled plasma-mass spectrometry (ICP-MS) or the like. When the content of the magnetic metal M is 0.1 wt % or greater, the attraction effect with respect to the surface 60s of the electrode active material 60 can be obtained. When the content of the magnetic metal M is 5 wt % or less, the magnetic metal M released from the metal-containing carbon nanotubes CNTm due to ionization or the like will be limited.

Preferably, the ratio of the coverage of the inorganic nanoparticles 70 to the content of the magnetic metal M (coverage/content) is, for example, 38.5 or less. In one example, the value obtained from the ratio of the coverage of the inorganic nanoparticles 70 (%) to the content of the magnetic metal M (wt %) is 1.0 or greater and 38.5 or less. The inorganic nanoparticles 70 on the surface 60s of the electrode active material 60 improve the powder flowability while increasing the battery output with the carbon nanotubes CNT.

Preferably, the content of the carbon nanotubes CNT contained in the electrode mixture 50 is, for example, 5 wt % or less when the electrode mixture 50 is dry. An increase in the content of the carbon nanotubes CNT contained in the electrode mixture 50 will increase the viscosity of the electrode mixture 50. Nevertheless, as long as the content of the carbon nanotubes CNT contained in the electrode mixture 50 is 5 wt % or less, the preferred flowability of the electrode mixture 50 can be obtained.

When multi-walled carbon nanotubes (MW-CNT) are used as the carbon nanotubes CNT mixed in the electrode mixture 50, the content in the electrode mixture 50 in a dry state is preferably 0.4 wt % or greater. When single-walled carbon nanotubes (SW-CNT) are used as the carbon nanotubes CNT mixed in the electrode mixture 50, the content in the electrode mixture 50 in a dry state is preferably 0.04 wt % or greater. The application of the inorganic nanoparticles 70 to the surface 60s of the electrode active material 60 improves the powder flowability, and the use of conductive material as the carbon nanotubes CNT increases the battery output.

Advantages

The advantages of the present embodiment will now be described.
(1) The carbon nanotubes CNT are mixed as the conductive fibrous carbon material 51 in the electrode mixture 50. The carbon nanotubes CNT serving as conductive material increases the battery output.
(2) The inorganic nanoparticles 70 applied to the surface 60s of the electrode active material 60 improves the powder flowability of the electrode active material 60. This facilitates handling of the electrode active material 60 when manufacturing the electrode mixture 50 and improves productivity of the electrode mixture 50.
(3) The metal-containing carbon nanotubes CNTm, which contain the magnetic metal M therein, are readily and directly adhered to the surface 60s of the electrode active material 60 because of the attraction effect of the magnetic metal M even under a situation in which the inorganic nanoparticles 70 are coexisting. This obtains a high battery performance.
(4) Further, the ratio of the coverage of the inorganic nanoparticles 70 covering the surface 60s of the electrode active material 60 to the content of the magnetic metal M contained in the metal-containing carbon nanotubes CNTm (coverage/content) is set to be 38.5 or less. This obtains flowability of the electrode active material 60, which serves as the raw material of the electrode mixture 50, and increases the battery output.

The above embodiment may be modified as described below. The above embodiment and the modified examples described below may be combined as long as there is no technical contradiction.

In the above embodiment, the carbon nanotubes CNT are used as the conductive fibrous carbon material 51. Instead, for example, any conductive fibrous carbon material such as carbon nanofibers (CNF) may be used as long as the carbon nanofibers form a conductive path in the electrode mixture 50 in the electrode active material 60 that is proximate to the carbon nanofibers.

In addition to alumina, for example, an oxide such as lithium tungstate, zirconium oxide, titanium oxide, niobium oxide, molybdenum oxide, magnesium oxide, or tungsten oxide may be used as the inorganic nanoparticles 70. A fluoride such as aluminum fluoride, lithium fluoride, or the like may be used. Alternatively, lithium nickel oxide, lithium cobalt oxide, or the like may be used. Nevertheless, it is preferable that the inorganic nanoparticles 70 be significantly smaller in diameter than the electrode active material 60.

The electrode mixture 50 may have any structure. For example, the lithium transition metal oxide that forms the electrode active material 60 may have any composition. As long as the magnetic metal M, which is contained in the metal-containing carbon nanotubes CNTm, can be attracted, the electrode mixture 50 may have any structure. The primary particles and secondary particles may have any diameter. Further, there is no limit to the type and physical properties of the binder mixed in the electrode mixture 50. The electrode mixture 50 may also include an additive although this is not a necessity. For example, the electrode mixture 50 does not have to use a typical binder, and may carry the electrode active material 60 with only the conductive fibrous carbon material 51.

There are no limitations to the diameter of the inorganic nanoparticles 70, the content of the inorganic nanoparticles 70 in the electrode mixture 50, the length and diameter of the carbon nanotubes CNT, and the content of the carbon nanotubes CNT in the electrode mixture 50. There is no limit to the numerical ranges described above, which are only examples. For example, the numerical values described above may be varied in accordance with the structure of the electrode mixture 50, such as the type or physical properties of the binder, or the specification of the electrode active material 60.

The above embodiment is applied to the electrode mixture 50 for the positive electrode that is used to form the positive electrode active material layer 32P. Instead, the above embodiment may be applied to the electrode mixture 50 for the negative electrode that is used to form the negative electrode active material layer 32N as long as the electrode mixture 50 includes the inorganic nanoparticles 70, which are applied to the surface 60s of the electrode active material 60, in addition to the particulate electrode active material 60 and the conductive fibrous carbon material 51.

Further, the above embodiment is applied to the electrode mixture 50 used to form the rechargeable battery 1 that is a lithium-ion rechargeable battery. Instead, the above embodiment may be applied to a rechargeable battery 1 that is not a lithium-ion battery.

The positive electrode terminal 38P and the negative electrode terminal 38N do not have to be shaped as shown in FIG. 1 and may have any shape. The case 20, which forms the shell of the rechargeable battery 1, does not need to have the form of a flattened box and may have any form such as the form of a cylinder.

### EXAMPLES

Examples will now be described to illustrate the structure and advantages of the present invention in further detail. The present embodiment is not limited to these examples.

Inorganic Particles, Magnetic Metal Contained in Carbon Nanotubes

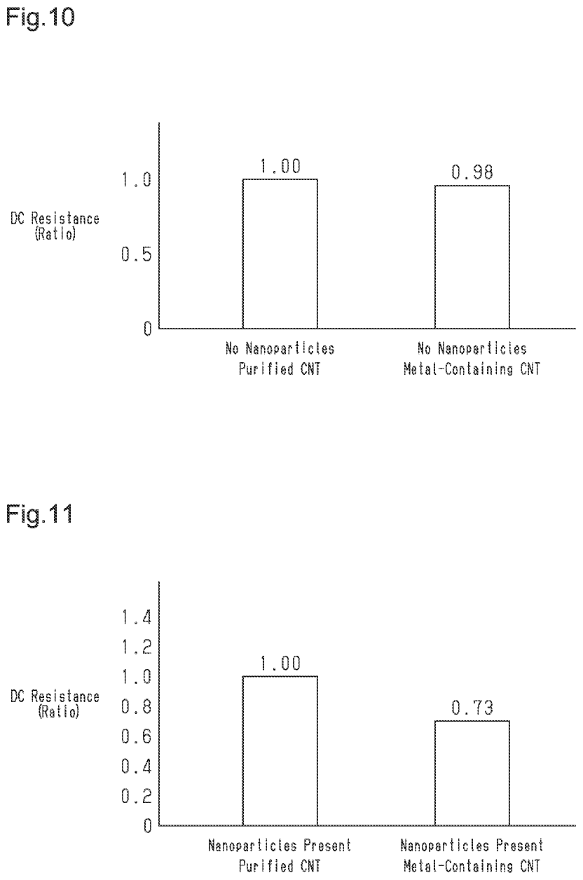

FIGS. 10 to 15 are graphs comparing the battery performance when the inorganic nanoparticles 70 are present and not present and comparing the battery performance when the magnetic metal M of the carbon nanotubes CNT are present and not present.

The measurements shown in the drawings were obtained through performance tests conducted on the electrode mixture 50 for the positive electrode. The composition of the electrode mixture 50 was such that the ratio of the positive electrode active material 61, the conductive material, and the binder was 98:1:1. Polyvinylidene fluoride (PVdF) was used as the binder.

The carbon nanotubes CNT contained in the electrode mixture 50 had an average length of 1000 nm and an average diameter of 10 nm. Further, the content of the magnetic metal M contained in the metal-containing carbon nanotubes CNTm was 1.2 wt %, and the content of the magnetic metal M contained in the purified carbon nanotubes CNTm0 was 0 (undetected). The content of the carbon nanotubes CNT contained in the electrode mixture 50 was 1.0 wt % in a dry state.

Alumina particles were used as the inorganic nanoparticles 70. The electrode mixture 50 containing the inorganic nanoparticles 70 was adjusted so that the coverage of the inorganic nanoparticles 70 covering the surface 60s of the electrode active material 60 was 5%.

For the sake of convenience, in the description hereafter, a state in which the inorganic nanoparticles 70 are not present will be indicated as “no nanoparticles,” and a state in which the inorganic particles are present will be indicated as “nanoparticles present.” The metal-containing carbon nanotubes CNTm are referred to as “metal-containing CNT” and the purified carbon nanotubes CNTm0 are referred to as “purified CNT.” Indexes related to the battery performance will be indicated in the drawings as “DC resistance,” “reaction resistance,” “total resistance,” and “penetration resistance.”

More specifically, “DC resistance,” “reaction resistance,” and “total resistance” are each measured through an alternating current impedance method and indicate the internal resistance of the rechargeable battery 1, and “total resistance” is directly obtained through the alternating current impedance method. Further, “reaction resistance” is obtained through Nyquist plot outputs, and indicates the resistance when electrons are transferred in the surface 60s of the electrode active material 60. In addition, “DC resistance” is also obtained through Nyquist plot outputs, and indicates the resistance when electrodes move in the electrode mixture. The conductive material in the electrode mixture 50, that is, the carbon nanotubes CNT serving as the conductive fibrous carbon material 51 form a conductive path and lowers the DC resistance.

“Penetration resistance” is the resistance value obtained through a two-terminal resistance measurement, or penetration resistance test, that arranges the electrode sheet 35, on which the electrode mixture 50 is formed, between electrodes. “Penetration resistance” has the same tendency as “DC resistance.” More specifically, the conductive material in the electrode mixture 50 forms a conductive path and lowers the value of the penetration resistance.

FIG. 10 compares the purified carbon nanotubes CNTm0 with the metal-containing carbon nanotubes CNTm when there were no inorganic nanoparticles 70 on the surface 60s of the electrode active material 60, which is the state indicated as “no nanoparticles.” The comparison shows that the difference in battery performance was small when using the purified carbon nanotubes CNTm0 and when using the metal-containing carbon nanotubes CNTm.

FIG. 11 compares the purified carbon nanotubes CNTm0 with the metal-containing carbon nanotubes CNTm when the inorganic nanoparticles 70 were present on the surface 60s of the electrode active material 60, which is the state indicated as “nanoparticles present.” The comparison shows that the battery performance was improved when using the metal-containing carbon nanotubes CNTm as compared with when using the purified carbon nanotubes CNTm0.

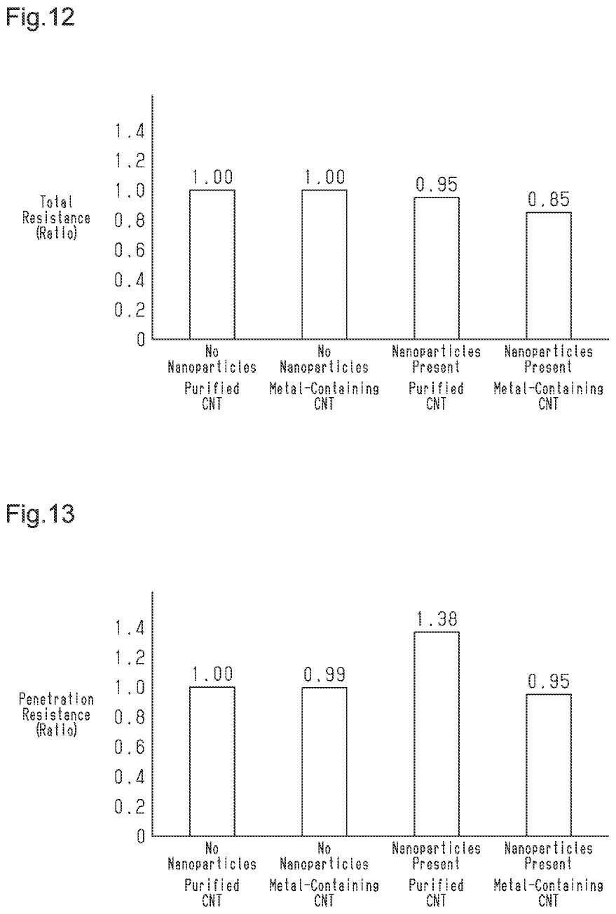

Four combinations of when the inorganic nanoparticles 70 were present, when there were no inorganic nanoparticles 70, when the carbon nanotubes CNT contained the magnetic metal M, and when the carbon nanotubes CNT did not contain the magnetic metal M were compared to evaluate the battery performance with different kinds of resistances. In FIGS. 12 to 15, the combination of “no nanoparticles” and “purified CNT” was used as a base (1.0) and compared with another combination to obtain a ratio of the resistances.

FIG. 12 shows that there was no difference in “total resistance” between the combination of “no nanoparticles” and “purified CNT” and the combination of “no nanoparticles” and “metal-containing CNT” (both ratios were 1.00). In comparison, the combination of “nanoparticles present” and “purified CNT” resulted in a slight decrease in “total resistance” (ratio was 0.95). The combination of “nanoparticles present” and “metal-containing CNT” resulted in a greater decrease in “total resistance” (0.85) thereby indicating that the battery performance was improved.

FIG. 13 shows that the difference in “penetration resistance” was small between the combination of “no nanoparticles” and “purified CNT” (1.00) and the combination of “no nanoparticles” and “metal-containing CNT” (0.99). There was an increase in “penetration resistance” (1.38) with the combination of “nanoparticles present” and “purified CNT.” The combination of “nanoparticles present” and “metal-containing CNT” resulted in a slight decrease in “penetration resistance” (0.95).

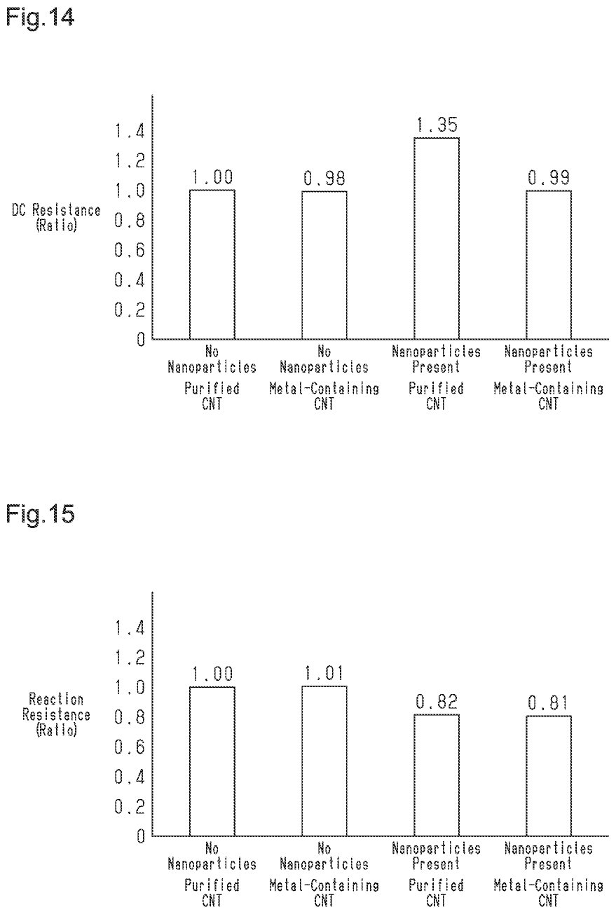

FIG. 14 shows that the difference in “DC resistance” was small between the combination of “no nanoparticles” and “purified CNT” (1.00) and the combination of “no nanoparticles” and “metal-containing CNT” (0.98). There was an increase in “DC resistance” with the combination of “nanoparticles present” and “purified CNT” (1.35). The difference in DC resistance was small between the base combination of “no nanoparticles” and “purified CNT” and the combination of “nanoparticles present” and “metal-containing CNT” (0.99).

The results of FIGS. 13 and 14 show that when the inorganic nanoparticles 70 coexist with the purified carbon nanotubes CNTm0, the purified carbon nanotubes CNTm0 cannot form a conductive path in the electrode mixture 50. This indicates that the inorganic nanoparticles 70 on the surface 60s of the electrode active material 60 interferes with the purified carbon nanotubes CNTm0 that contacts the surface 60s of the electrode active material 60 (refer to FIG. 7).

Further, the results of FIGS. 13 and 14 show that when the inorganic nanoparticles 70 coexist with the metal-containing carbon nanotubes CNTm, the metal-containing carbon nanotubes CNTm form a conductive path in the electrode mixture 50. Such results shows that the magnetic metal M contained in the metal-containing carbon nanotubes CNTm is attracted to the electrode active material 60. Thus, the metal-containing carbon nanotubes CNTm are easily adhered to the surface 60s of the electrode active material 60 (refer to FIG. 9).

FIG. 15 shows that the difference in “reaction resistance” is small between the combination of “no nanoparticles” and “purified CNT” (1.00) and the combination of “nanoparticles present” and “metal-containing CNT” (1.01). The value of “reaction resistance” was low in the combination of “nanoparticles present” and “purified CNT” (0.82) and the combination of “nanoparticles present” and “metal-containing CNT” (0.81). This shows that electrons were readily transferred in the surface 60s of the electrode active material 60.

Nanoparticle Coverage and Content of Magnetic Metal Contained in Carbon Nanotubes

The effect of the coverage of the inorganic nanoparticles 70 and the content of the magnetic metal M contained in the carbon nanotubes CNT on the battery performance was measured under an environment in which the inorganic nanoparticles 70 coexisted with the carbon nanotubes CNT.

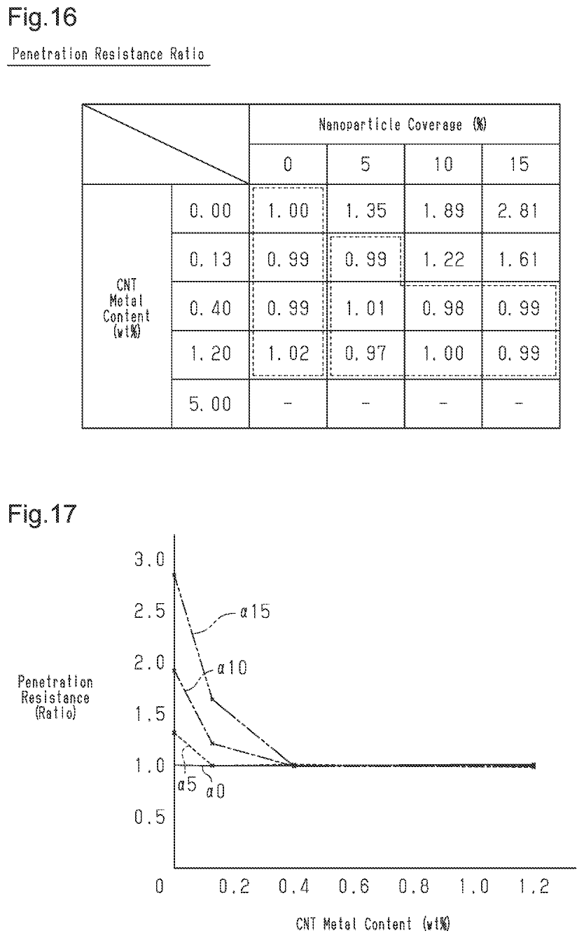

FIG. 16 is a table and FIG. 17 is a graph showing the measurement results of the battery performance with the relationship of the coverage of the inorganic nanoparticles 70 covering the surface 60s of the electrode active material 60 and the content of the magnetic metal M contained in the carbon nanotubes CNT. The figures show the results of battery performance tests conducted by measuring the penetration resistance. For the sake of convenience, the coverage of the inorganic nanoparticles 70 is indicated as “nanoparticle coverage” and the content of the magnetic metal M contained in the carbon nanotubes CNT is indicated as “CNT metal content.” These figures are also based on the combination of “no nanoparticles” and “purified CNT” in which “nanoparticle coverage” and “CNT metal content” were both 0%. More specifically, the penetration resistance of the combination of “no nanoparticles” and “purified CNT” was used as a base set to 1.00 and compared with the penetration resistance of another combination to obtain a ratio.

The battery performance results shown in the figures were also obtained through tests conducted on the combinations of “no nanoparticles,” “nanoparticles present,” “purified CNT,” and “metal-containing CNT” that were the same as those used in the previously mentioned test and had the same composition in the electrode mixture 50. For example, the carbon nanotubes CNT contained in the electrode mixture 50 had an average length of 1000 nm and an average diameter of 10 nm. The content of the carbon nanotubes CNT contained in the electrode mixture 50 was 0.4 wt % in a dry state. Tests were conducted with “nanoparticle coverage” set to 0%, 5%, 10%, or 15%. Further, “CNT metal content” was set to 0.00 wt %, 0.13 wt %, 0.40 wt %, or 1.20 wt %. Performance tests were conducted on each combination of such values of “nanoparticle coverage” and “CNT metal content.”

In FIG. 17, line α0 shows the measurement result when “nanoparticle coverage” was 0%, and line α5 shows the measurement result when “nanoparticle coverage” was 5%. Line α10 shows the measurement result when “nanoparticle coverage” was 10%, and line α15 shows the measurement result when “nanoparticle coverage” was 15%.

As shown in FIGS. 16 and 17, when “nanoparticle coverage” was “0%” and “CNT metal content” was changed, the value of “penetration resistance ratio” did not change much (1.0→0.99→0.99→1.02 in order from smaller content). Thus, “CNT metal content” has little effect on the battery performance when there were “no nanoparticles.”

The value of “penetration resistance ratio” increased (1.35) when “nanoparticle coverage” was 5% and CNT metal content was 0.00 wt %, that is, “purified CNT” was used. The test results obtained when “CNT metal content” was 0.13 wt %, 0.40 wt %, or 1.20 wt % were similar to the test results obtained under the condition of “no nanoparticles” (0.99→1.01→0.97 in order from smaller content).

When “nanoparticle coverage” was 10% and “CNT metal content” was 0.00 wt % or 0.13 wt %, the value of “penetration resistance ratio” increased (1.89 and 1.22). The test results obtained when “CNT metal content” was 0.40 wt % or 1.20 wt % were similar to the test results obtained under the test condition of “no nanoparticles” (0.98 and 1.00).

When “nanoparticle coverage” was 15% and “CNT metal content” was 0.00 wt % or 0.13 wt %, the value of “penetration resistance ratio” increased (2.81 and 1.61). The test results obtained when “CNT metal content” was 0.40 wt % or 1.20 wt % were similar to the test results obtained under the test condition of “no nanoparticles” (0.99 and 0.99).

It is understood from the above results that the preferred “CNT metal content” is generally 0.1 wt % or greater. It is further preferable that “CNT metal content” be 0.4 wt % or greater.

Nanoparticle Coverage/CNT Metal Content

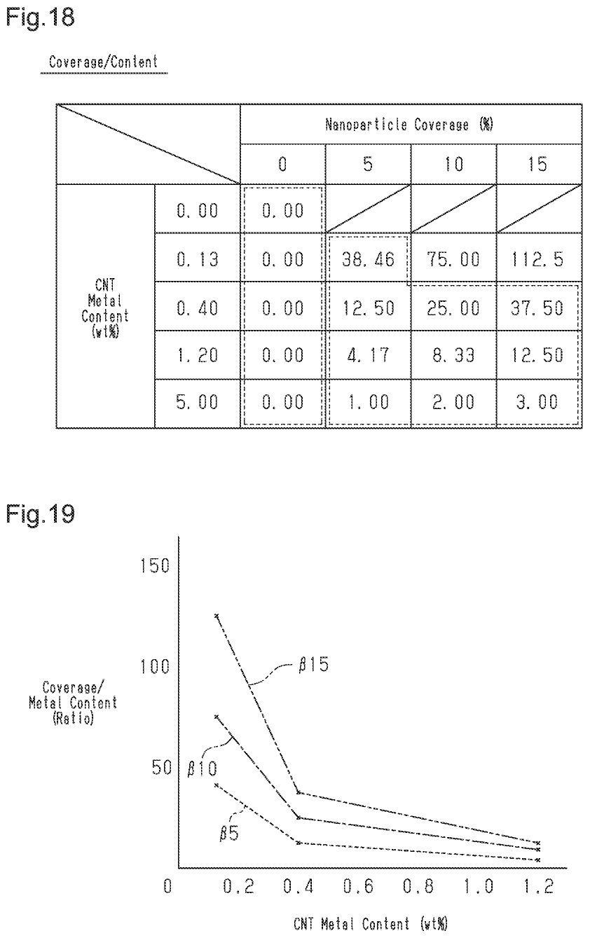

FIG. 18 is a table and FIG. 19 is a graph showing the ratio of “nanoparticle coverage” to “CNT metal content” for each combination of “nanoparticle coverage” and “CNT metal content.” In FIG. 19, line β5 shows the ratio when “nanoparticle coverage” was 5%. Line β10 shows the ratio when “nanoparticle coverage” was 10%, and line β15 shows the ratio when nanoparticle coverage was 15%.

As shown in FIG. 18, the value of “nanoparticle coverage/CNT metal content” was 38.46 when “nanoparticle coverage” was 5% and “CNT metal content” was 0.13 wt %. As “CNT metal content” increased in the order of 0.40 wt %, 1.20 wt %, and 5.00 wt %, the ratio decreased (12.50→4.17→1.00).

The value of “nanoparticle coverage/CNT metal content” was 75.00 when “nanoparticle coverage” was 10% and “CNT metal content” was 0.13 wt %. The value of the ratio was 25.00 when “CNT metal content” was 0.40 wt %. As “CNT metal content” increased to 1.20 wt % and 5.00 wt %, the ratio decreased (8.33→2.00).

The value of “nanoparticle coverage/CNT metal content” was 112.5 when “nanoparticle coverage” was 15% and “CNT metal content” was 0.13 wt %. The value of the ratio was 37.50 when “CNT metal content” was 0.40 wt %. As “CNT metal content” increased to 1.20 wt % and 5.00 wt %, the ratio decreased (12.50→3.00).

Thus, when “nanoparticle coverage” was 5%, the same battery performance as where there were “no nanoparticles” was obtained when “CNT metal content” was 0.13 wt % or greater (refer to FIGS. 16 and 17). In this case, the value of “nanoparticle coverage/CNT metal content” was 38.5 or less.

When “nanoparticle coverage” was 10% and 15%, the same battery performance as where there were “no nanoparticles” was obtained when “CNT metal content” was 0.40 wt % or greater. In these cases, the value of “nanoparticle coverage/CNT metal content” was 25.0 or less and 37.5 or less.

It is understood from the above results that the preferred “nanoparticle coverage/CNT metal content” is approximately 38.5 or less. The value of the ratio is more preferably 37.5 or less. The value of the ratio is further preferably 25.0 or less.

Multi-Walled CNT and Single-Walled CNT

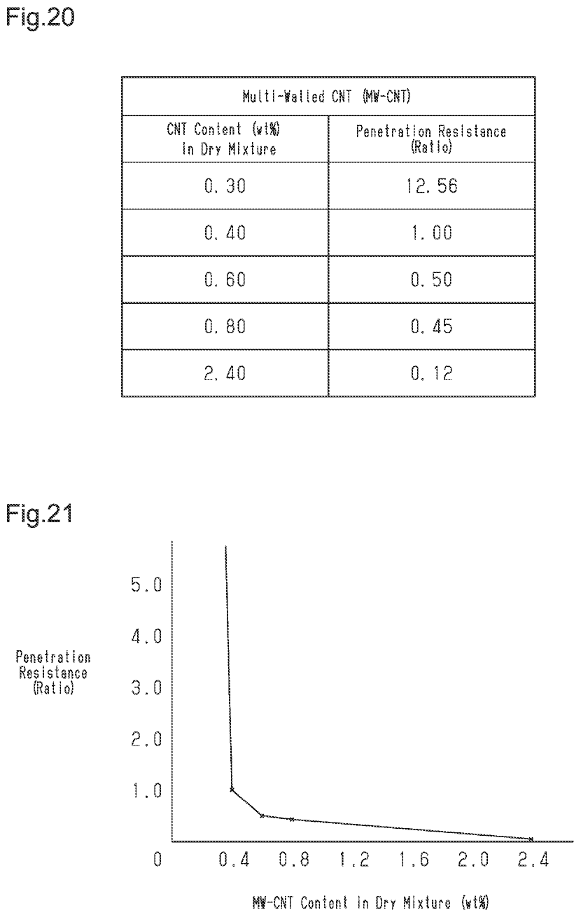

FIGS. 20 and 21 show the relationship of the content of the carbon nanotubes CNT contained in the electrode mixture 50 and the battery performance when the carbon nanotubes CNT are multi-walled carbon nanotubes (MW-CNT).

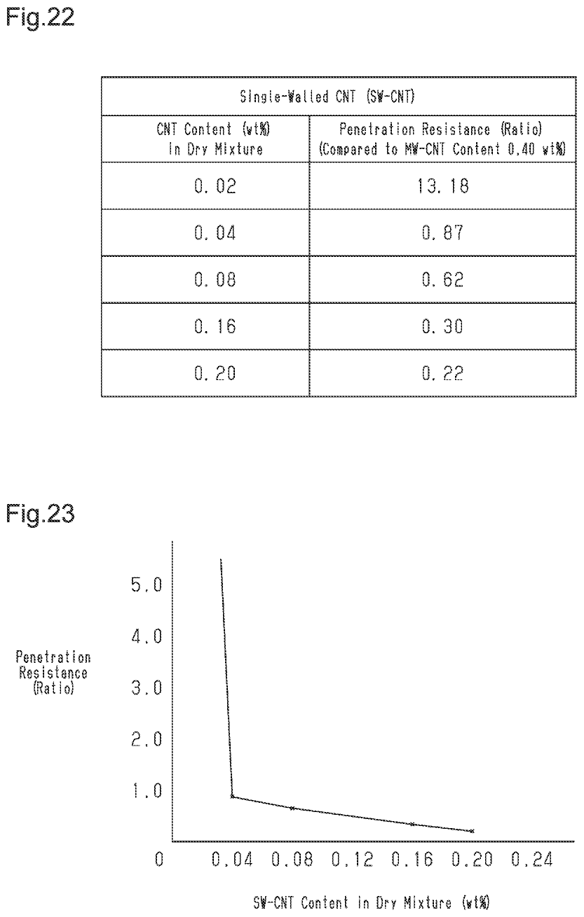

FIGS. 22 and 23 show the relationship of the content of the carbon nanotubes CNT contained in the electrode mixture 50 and the battery performance when the carbon nanotubes CNT are single-walled carbon nanotubes (SW-CNT).

The content of the carbon nanotubes CNT is the percent by weight in the electrode mixture 50 in a dry state. The measurement results shown in the figures were obtained through tests conducted to measure the penetration resistance as the battery performance. Further, for the sake of convenience, in the description, multi-walled carbon nanotubes are indicated as “multi-walled CNT,” single-walled carbon nanotubes are indicated as “single-walled CNT,” and the content of the carbon nanotubes CNT contained in the electrode mixture 50 is indicated as “CNT content.” In the figures, “penetration resistance” is indicated as a ratio obtained when setting the penetration resistance measured for the CNT content of 0.40 wt % to 1.00.

As shown in FIGS. 20 and 21, the use of “multi-walled CNT” increased the “CNT content.” As the “CNT content” increases, “penetration resistance ratio” is decreased by a greater amount. More specifically, when “CNT content” was set to 0.60 wt %, 0.80 wt %, and 2.40 wt %, which are higher than the base of 0.40 wt %, the values of “penetration resistance ratio” were respectively 0.50, 0.45, and 0.12. When “CNT content” was set to 0.30 wt %, which is lower than 0.40 wt %, the value of “penetration resistance ratio” increased greatly to 12.56. Thus, it can be understood from the above results that the preferred “CNT content” when using “multi-walled CNT” is 0.40 wt % or greater.

Further, as shown in FIGS. 22 and 23, the use of “single-walled CNT” also increases the “CNT content.” As the “CNT content” increases, “penetration resistance ratio” is decreased by a greater amount. More specifically, when the “CNT content” was set to 0.04 wt %, 0.87 was obtained which is the closest to the base value (1.00) of the “penetration resistance ratio.” When “CNT content” was set to 0.08 wt %, 0.16 wt %, and 0.20 wt %, which are higher than 0.04 wt %, the values of “penetration resistance value” were respectively 0.62, 0.30, and 0.22. When “CNT content” was set to 0.02 wt %, which is lower than 0.04 wt %, the value of “penetration resistance ratio” increased greatly to 13.18. Thus, it can be understood from the above results that the preferred “CNT content” when using “single-walled CNT” is 0.04 wt % or greater.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An electrode mixture, comprising:
an electrode active material;
a conductive fibrous carbon material; and
inorganic nanoparticles applied to a surface of the electrode active material, wherein
the conductive fibrous carbon material contains a magnetic metal, and
a ratio of coverage of the inorganic nanoparticles covering the surface of the electrode active material to content of the magnetic metal contained in the conductive fibrous carbon material is 38.5 or less.

2. The electrode mixture according to claim 1, wherein the coverage of the inorganic nanoparticles is 5% or greater and 15% or less.

3. The electrode mixture according to claim 1, wherein the content of the magnetic metal is 0.1 wt % or greater and 5 wt % or less.

4. The electrode mixture according to claim 1, wherein:
the conductive fibrous carbon material is multi-walled carbon nanotubes; and
content of the conductive fibrous carbon material contained in the electrode mixture is 0.4 wt % or greater.

5. The electrode mixture according to claim 1, wherein:
the conductive fibrous carbon material is single-walled carbon nanotubes; and
content of the conductive fibrous carbon material contained in the electrode mixture is 0.04 wt % or greater.

6. A rechargeable battery, comprising:
the electrode mixture according to claim 1.
